(19) United States
(12) Patent Application Publication
(10) Pub. No.: US 2020/0005501 A1
(43) Pub. Date: Jan. 2, 2020

(54) SYSTEM AND METHOD OF REPRESENTING A LINE SEGMENT WITH TWO THIN TRIANGLES

(71) Applicant: Samsung Electronics Co., Ltd., Suwon-si (KR)

(72) Inventors: Kevin WU, Palo Alto, CA (US); Lam V. NGUYEN, Cupertino, CA (US); Chris GOODMAN, Round Rock, TX (US)

(21) Appl. No.: 16/133,633

(22) Filed: Sep. 17, 2018

Related U.S. Application Data
(60) Provisional application No. 62/692,736, filed on Jun. 30, 2018.

(51) Int. Cl. G06T 11/20; G06T 1/20; G06T 3/40

(52) U.S. Cl. CPC G06T 11/203; G06T 3/40; G06T 1/20

(57) ABSTRACT

A line segment is rendered by two triangles joined by their hypotenuses. A graphics processing system includes a lookup table that contains a plurality of values representing reciprocal square roots for normal vectors to a corresponding plurality of line segments. The dot product of a normal vector to the line segment is scaled by a scaling factor and input to the lookup table. The scaling factor has a trivial/simple square root and is a power of 2 so that multiplication of binary values may be performed by shifting. A value is output from the lookup table representing a reciprocal square root of the normal vector to the line segment. A half unit normal vector to the line segment is determined based on the normal vector to the line segment and the output value and is used to determine the two triangles for rendering the line segment.

### CROSS-REFERENCE TO RELATED APPLICATION

This patent application claims the priority benefit under 35 U.S.C. § 119(e) of U.S. Provisional Patent Application No. 62/692,736, filed on Jun. 30, 2018, the disclosure of which is incorporated herein by reference in its entirety.

### TECHNICAL FIELD

The subject matter disclosed herein generally relates to a system and a method to render line segments using two triangles joined by their hypotenuses.

### BACKGROUND

In a Graphics Processing Unit (GPU), an aliasing line may be represented by two triangles joined at their hypotenuses for an application programming interface (API) or to facilitate anti-aliasing to smooth the appearance of a line. In effect, the width of a line is widened so that the line is one pixel wide in order to intersect more sample points and reduce a jagged appearance.

To form the two triangles, a half normal vector (hnx, hny) to the line may be determined by scaling, or dividing, a unit vector of the line by half of its length, and then rotating half normal vector counter-clockwise 90 degrees. The half normal vector (hnx, hny) is a vector that is perpendicular to the line having a length of 0.5 pixel. A reciprocal square root function having a wide input domain (e.g., 40 bits of integer and 28 bits of fraction) may be needed to determine the half normal vector of a long line. A reciprocal square root function having such a wide input domain may be impractical for a handheld device, such as a smart phone or other similar type device for power consumption reasons.

### SUMMARY

An example embodiment provides a graphics processing system that may include a lookup table and a graphics processor. The lookup table may containing a plurality of values representing reciprocal square roots for normal vectors to a corresponding plurality of line segments. The graphics processor may receive a first vertex and a second vertex of a first line segment that is to be rendered as two triangles. The graphics processor may input an input value to the lookup table in which the input value may be 2 to a negative power of an integer L times a dot product of a normal vector to the first line segment with itself. The graphics processor may receive an output value from the lookup table that represents a reciprocal square root of the normal vector to the first line segment and determining a unit normal vector to the first line segment by multiplying the normal vector to the first line segment by the output value received from the lookup table. The graphics processor may further determine a first half unit normal vector and a second half unit normal vector to the first line segment from the unit normal vector and the first vertex and the second vertex of the first line segment, and determine a first triangle and a second triangle based on the first and second half normal vectors and the first vertex and the second vertex of the first line segment in which the first and second triangles each include a hypotenuse and are joined together by their hypotenuses. In one embodiment, the graphics processor may further render the first line segment by rendering the first and second triangles. In another embodiment, the graphics processor may further scale a length of each of the first and second half normal vectors to be half of a predetermined line width of the rendered line segment.

Another example embodiment provides a method to graphically represent a line segment by two triangles that may include: receiving at a graphics processor a first vertex and a second vertex of a line segment; determining by the graphics processor a scaling factor that is equal to 4 to a power of an integer L; inputting an input value to a lookup table by the graphics processor in which the input value may be 2 to a negative power of L times a dot product of a normal vector to the line segment with itself; receiving by the graphics processor from the lookup table an output value that equals a reciprocal square root of the input to the lookup table; determining by the graphics processor a unit normal vector to the line segment by dividing the normal vector to the line segment by the output value received from the lookup table; determining by the graphics processor a first half normal vector and a second half normal vectors to the line segment from the unit normal vector and the first vertex and the second vertex of the line segment; determining by the graphics processor a first triangle and a second triangle based on the first and second half normal vectors and the first vertex and the second vertex of the line segment in which the first and second triangles each include a hypotenuse and are joined together by their hypotenuses; and graphically rendering the line segment by the graphics processor by rendering the first and second triangles. In one embodiment, determining the first and second half normal vectors may further include scaling a length of each of the first and second half normal vectors to be half of a predetermined line width of the rendered line segment.

Still another example embodiment provides a method to graphically represent a line segment by two triangles that may include: receiving at a graphics processor a first vertex v₀ and a second vertex v₁ of a line segment; determining by the graphics processor a scaling factor P=4^{L} in which L is an integer value given by L=└log₄(n·n)┘ and in which n is a normal vector to the line segment, and n·n is a dot product of the normal vector n with itself; inputting an input value a into a lookup table by the graphics processor in which the input value may be a=2^{-2L}(n·n); receiving by the graphics processor from the lookup table an output value b=S(2^{-2L}(n·n)); determining by the graphics processor a unit normal vector \hat{n} to the line segment by multiplying the normal vector n to the line segment by the output value b received from the lookup table; determining by the graphics processor a first normal half vector h [symbol] and a second half normal vector h [symbol] to the line segment from the unit normal vector ĥ and the first vertex v₀ and the second vertex v₁ of the line segment; determining by the graphics processor a first triangle and a second triangle based on the first half normal vector h [symbol] and the second half normal vector h [symbol] and the first vertex v₀ and the second vertex v₁ of the line segment in which the first and second triangles each comprising a hypotenuse and being joined together by their hypotenuses; and graphically rendering the line segment by the graphics processor by rendering the first and second triangles. In one embodiment, wherein determining the first half normal vector h [symbol] and the second half normal vector h [symbol] may further include scaling a length of each of the first half normal h [symbol] vector and the second half normal vector h [symbol] to be half of a predetermined line width of the rendered line segment.

### BRIEF DESCRIPTION OF THE DRAWINGS

In the following section, the aspects of the subject matter disclosed herein will be described with reference to exemplary embodiments illustrated in the figures, in which:

FIG. 1 depicts an aliasing line segment having vertices v₀ and v₁ that is to be formed by a GPU into two triangles representing the line segment having a width of one pixel;

FIG. 2 depicts a typical flow diagram for directly computing the vertices of the two triangles that joined at their hypotenuses to render a smoothed line; and

FIG. 3 depicts a flow diagram for directly computing the vertices of the two triangles that joined at their hypotenuses to render a smoothed line according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement the teachings of particular embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. The software may be embodied as a software package, code and/or instruction set or instructions, and the term “hardware,” as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-chip (SoC) and so forth.

The subject matter disclosed herein provides a system and a method for determining a half unit normal vector h\hat{n} for a line segment that uses a lookup table for the reciprocal square root function in which the lookup table has a limited input domain and that may be used with handheld devices, such as a smart phone. In one embodiment, input of a reciprocal square root function is transformed to be 18 bits and the output to be 9 bits, and only one clock cycle is needed to complete a reciprocal square root operation to provide the same accuracy/resolution for lines having arbitrary length. The subject matter disclosed herein provides a lookup table that receives fixed-point input values and outputs fixed-point output values by scaling the dot product of the pre-normalized normal vector n to a value that is close to decimal 1.0. The desirable properties for the scale factor are that the scale factor has a trivial/simple reciprocal square root and is a power of 2 so that multiplication using the scale factor may be performed by shifting binary numbers.

Additionally, the subject matter disclosed herein reduces the computational/hardware complexity for representing a line as two triangles by reducing the size of a lookup table that provides a reciprocal square root function by limiting the input domain to the lookup table to be 18 bits wide (e.g., in an u2.16 format that is unsigned 2 bit integer with a 16 bit fraction). Moreover, an integer L that is used as part of a scaling factor may be calculated using a floor log₂ function instead of regular log₂ function, which would require an extremely large lookup table to provide a reciprocal square root function.

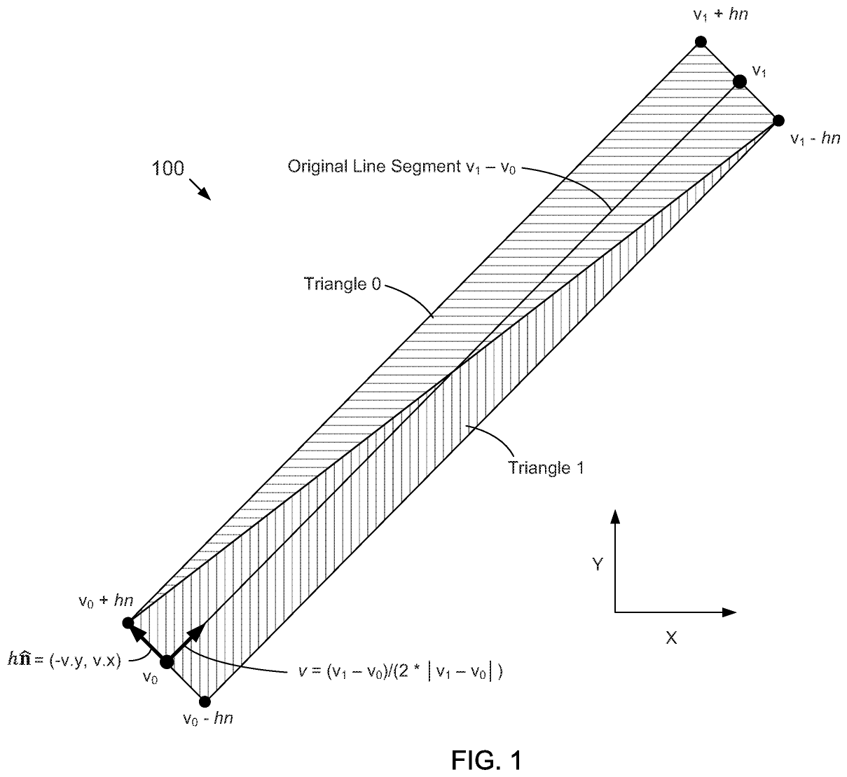

FIG. 1 depicts an aliasing line segment 100 having vertices v₀ and v₁ that is to be formed by a GPU into two triangles (triangle 0 and triangle 1) representing the line segment having a width of one pixel. The two vertices of the original line segment 100 may be defined as

v₀=[x₀ y₀]

and

v₁=[x₁ y₁]. (1)

A vector v spanning the length of the line segment from v₀ to v₁ may be formed by generating the difference between the two vertices as

v=v₁−v₀=[(x₁−x₀)(y₁−y₀)]. (2)

A normal vector n (not shown in FIG. 1) is orthogonal to the vector v. A definition of n that satisfies the direction requirement so that the dot product of n with v (i.e., n·v) is zero is

n=[nₓn_{y}]=[(y₀−y₁)(x₁−x₀)]. (3)

The normal vector n may also be referred to as a pre-normalized normal vector n herein because it has not yet been scaled to have a unit length.

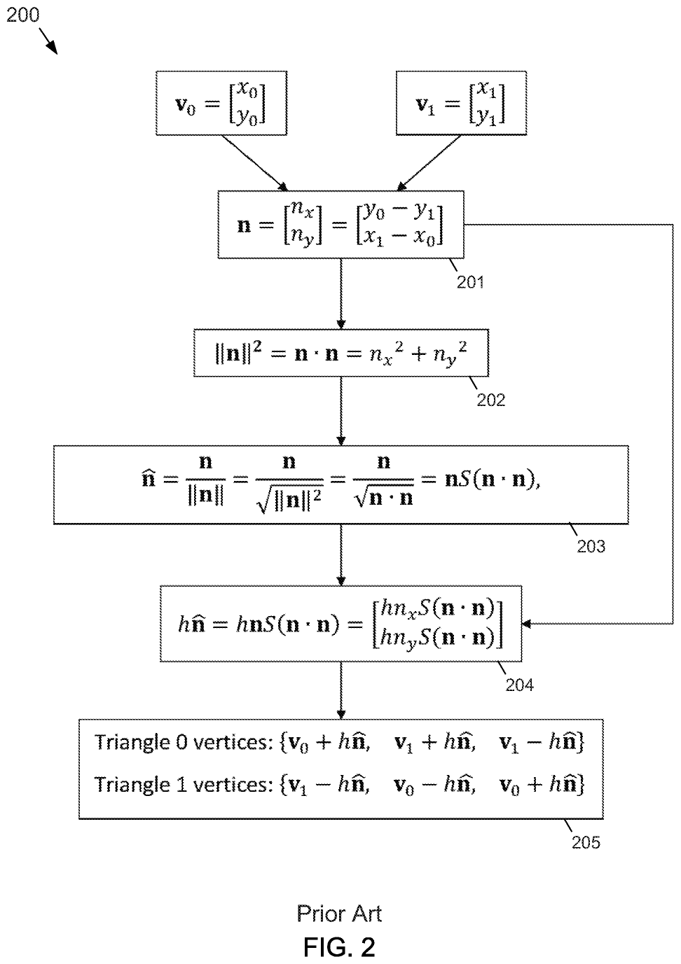

FIG. 2 depicts a typical flow diagram 200 for directly computing the vertices of the two triangles that joined at their hypotenuses to render a smoothed line. Diagram 200 may also be considered to depict a portion of a graphics pipeline. At 201, the vertices v₀ and v₁, which are received in the pipeline of, for example, a GPU, are used to form the normal vector n.

A unit normal vector \hat{n} may be scaled to form a half (i.e., half length) normal vector h\hat{n} (FIG. 1) in which the variable h is half of the line width. For example, for a line having a width of one pixel, the center of the line segment along its length is displaced by ½. To compute a unit normal vector \hat{n}, the magnitude of the normal vector n is needed, which may be obtained at 202 in FIG. 2 from the dot product of n·n as

∥n∥²=n·n=nₓ²+n_{y}². (4)

The unit normal vector \hat{n} may be formed at 203 by scaling, or dividing, the normal vector n with the reciprocal square root of the dot product n·n as

$$\hat{n} = \frac{n}{‖ n ‖} = \frac{n}{\sqrt{{‖ n ‖}^{2}}} = \frac{n}{\sqrt{n \cdot n}} = nS ( n \cdot n ) . \qquad ( 5 )$$

From Eq. (5), it can be seen that the reciprocal square root of n·n may be defined as

$$S ( n \cdot n ) = \frac{1}{\sqrt{n \cdot n}} . \qquad ( 6 )$$

At 204, a half unit normal vector h\hat{n} may be determined, and at 205 the vertices for triangle 0 and triangle 1 are then provided.

The reciprocal square root S(z) may be computed at 203 using a lookup table that provides a reciprocal square root function. The input domain of the reciprocal square root function lookup table, however, may be very large resulting in a lookup table that would be excessively large, particularly for a handheld device, such as a smartphone. Moreover, a look-up table having a piecewise polynomial order that is higher than 1 is generally expensive in hardware for such a wide input domain and would require more than 1 clock cycle to complete the reciprocal square root function.

For example, if the normal vector n is determined using vertices that are in a fixed-point format s18.8, which is a signed 19-bit integer having 8 bits of fraction, and if the range of the components of the normal vector n is limited to [0x40000.01, 0x3FFFF.FF] excluding only the most negative value 0x40000.00, then the components of the normal vector n formed from the difference between components of vertices will be in an s19.8 format having a range [0x80000.02, 0x7FFFF.FE]. As used herein, a number preceded by “0x” is a base-16 hexadecimal number. The dot product n·n would then be s19.8×s19.8+s19.8×s19.8 having a range [0x0.0001, 0x7FFFFFC000.0008] and would have a format u39.16, which has a very large domain. The number “u39.16” is in a fixed-point format having 39 bits of unsigned integer and 8 bits of fraction. Note that this range applies only to the dot product of the normal vector n having vector components that have been domain limited as described above.

Additionally for this example, the components of the half unit normal vector h\hat{n} should be in an s18.8 format so that they may be added to the s18.8 vertices of the original line segment. The components of the half unit normal vector may be purely fractional. If the line width is invariant at 1.0, the maximum absolute value of decimal 0.5, and may be represented as s0.8 for 8 bits of accuracy/resolution.

For this example of input domain [0x0.0001, 0x7FFFFFC000.0008], the output range is [0x0.000017, 0x100.000000]. So, in order to obtain 8 bits of accuracy/resolution, the reciprocal square root needs 24 bits of fraction necessitating a lookup table holding u9.24 values in order for the final half width vector to have at least 8 bits of fractional accuracy.

The input domain of the reciprocal square root function, however, is very large, and a look-up table for the entire domain would be excessively large. Additionally, look-up table with a piecewise polynomial order higher than 1 is generally expensive in hardware for a wide input, and would require more than 1 clock cycle to complete along with a greater power consumption.

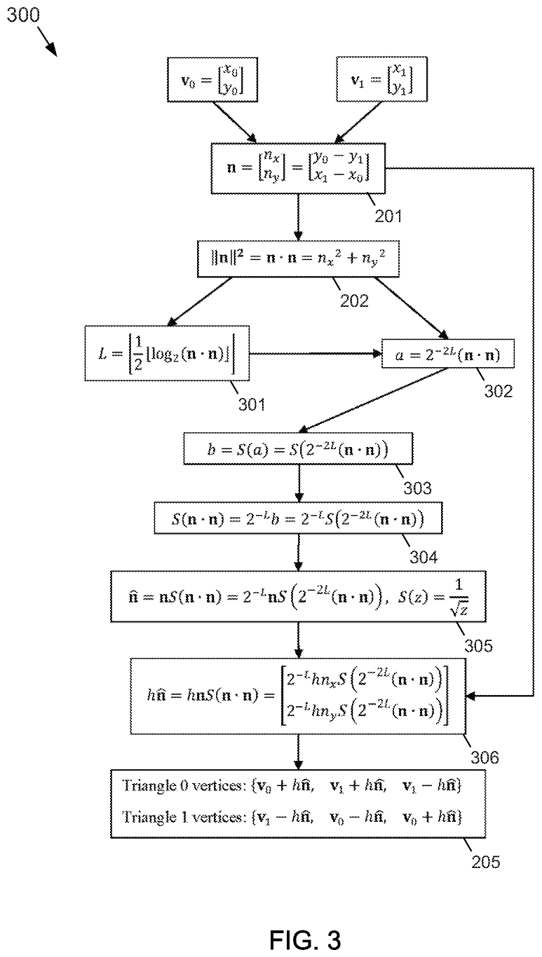

FIG. 3 depicts a flow diagram 300 for computing the vertices of the two triangles that joined at their hypotenuses to render a smoothed line according to the subject matter disclosed herein. Diagram 300 may also be considered to depict a portion of a graphics pipeline. Each block depicted in FIG. 3 may also be considered to be modules in a line-rendering portion of a GPU pipeline 301 that may be any combination of software, firmware and/or hardware configured to provide the functionality described herein in connection with a module. Any software associated with the blocks of FIG. 3 may be embodied as a software package, code and/or instruction set or instructions, and the term “hardware,” as used in any implementation described herein, may include, for example, singly or in any combination, hardwired circuitry, programmable circuitry, state machine circuitry, and/or firmware that stores instructions executed by programmable circuitry. The modules of FIG. 3 may, collectively or individually, be embodied as circuitry that forms part of a larger system, for example, but not limited to, an integrated circuit (IC), system on-chip (SoC) and so forth.

Similar to the flow diagram 200 in FIG. 2, the flow diagram 300/graphics pipeline 301 uses the vertices v₀ and v₁, which are received in the pipeline of, for example, a GPU, to form a normal vector n at 201 (in both FIGS. 2 and 3). The magnitude of the normal vector n may be obtained at 202 from the dot product of n·n.

At this point in the determination of the two triangles, the subject matter disclosed herein determines a scale factor P that has a trivial/simple reciprocal square root and that is a power of 2 so that multiplication using the scale factor may be performed by shifting binary numbers. In one embodiment, the scale factor P may be an integer power of 4, such as

P=4^{L}. (7)

The integer power L of 4 may be obtained by applying the inverse function log₄(x) to the dot product of the normal vector n with itself. Consider, for example, that the components of the input normal vector are in an s19.8 format. That is, the components of the input normal vector are in a format having a signed 19 bits of integer value and 8 bits of fractional value. Working with signed integer values may be easier when calculating integer power L of 4, and the following definition facilitates the transformation of the input components to become integer values

ñ=2⁸n (8)

in which n is the pre-normalized normal vector. This transformation maps n into ñ, thereby changing the s19.8 format of the input components of n to be in an s27.0 format (i.e., an integer value only). This transformation also provides that the unsigned format u39.16 of n·n is transformed into an unsigned format of u55.0 of ñ·ñ.

Alternatively, the bits of n may be interpreted as signed integers instead of fixed-point values. This change ensures no input bits are lost, and that short vectors that are less than one pixel in length are handled correctly.

Substituting n·n into log₄(x), the fractional bits of the output are not needed because an integer L is sought, and a floor function makes the calculation explicit:

$$\begin{matrix}L = ⌊ {log}_{4} ( n \cdot n ) ⌋ = ⌊ {log}_{4} ( {2}^{- 16} \tilde{n} \cdot \tilde{n} ) ⌋ & ( 9 ) \\ = ⌊ \frac{{log}_{2} ( {2}^{- 16} \tilde{n} \cdot \tilde{n} )}{{log}_{2} 4} ⌋ = ⌊ \frac{{log}_{2} ( \tilde{n} \cdot \tilde{n} ) - 16}{2} ⌋ = ⌊ \frac{⌊ {log}_{2} ( \tilde{n} \cdot \tilde{n} ) ⌋}{2} ⌋ - 8 & ( 10 ) \\ L = ( ⌊ {log}_{2} ( \tilde{n} \cdot \tilde{n} ) ⌋ >> 1 ) - 8 & ( 11 )\end{matrix}$$

in which “>>1” means shift one bit or binary digit to the right (and “>>k” means shifts k bits to the right). When the expression containing the operator for shifting right is preceded by an equal sign, the shift preserves all significant data without loss. The integer L is indicated at 301 in FIG. 3 as a function of the pre-normalized normal vector n.

The integer part of a base-2 logarithm may be computed in O(log(m)) time in which m is the number of bits of the input. Hardware implementations may make modifications, such as partitioning results of the intermediate steps and running successive steps in parallel on the small pieces to meet constraints. For the determination of the reciprocal square root, note that the range of ñ·ñ is [1, 2⁵⁵−1]. Consequently, the integer L has the range [−8, 19] in which −8 corresponds to the shortest vector and 19 corresponds to the longest vector.

Substituting the scale factor P from Eq. (7) into the reciprocal square root S allows a lookup table to be used that holds s18.8 values.

$$S ( n \cdot n ) = \frac{1}{\sqrt{n \cdot n}} = \frac{1}{\sqrt{\frac{{4}^{L}}{{4}^{L}} n \cdot n}} = \frac{1}{{2}^{L} \sqrt{{2}^{- 2 L} n \cdot n}} = \frac{{2}^{- L}}{\sqrt{{2}^{- 2 L} n \cdot n}} = ( \frac{1}{\sqrt{n \cdot n \text{>>} 2 L}} ) \text{>>} L \qquad ( 12 )$$

in which “>>L” means L shifts to the right.

A lookup table may be used to approximate S as

S(n·n)≈(R(n·n>>2L))>>L. (13)

The look-up table for reciprocal square root is R (a)=b for input a (at 302 in FIG. 3) and output b (at 303 in FIG. 3), in which

$$\begin{matrix}a = n \cdot n \text{>>} 2 L = {2}^{- 2 L} n \cdot n \\ and & ( 14 ) \\ b = R ( a ) = R ( n \cdot n \text{>>} 2 L ) = ( \frac{1}{\sqrt{n \cdot n \text{>>} 2 L}} ) . & ( 15 )\end{matrix}$$

At 304, it follows from Eqs. (13)-(15),

S(n·n)=2^{-L}b=2^{-L}S(2^{-2L}(n·n)), (16)

and at 305,

\hat{n}=nS(n·n)=2^{-L}nS(2^{-2L}(n·n)), (17)

in which

$$S ( z ) = \frac{1}{\sqrt{z}} .$$

The look-up table has a limited domain, and input a is within the limits. Recall that n·n may be a large number having format u39.16. The scaling disclosed herein shifts the large number (i.e., n·n) right by 2L bits to reduce the magnitude of the input to the look-up table. The integer L has been defined to make L the largest integer less than or equal to log₄(n·n).

There exists a non-negative fractional value f such that

$$\begin{matrix}{4}^{L + f} = n \cdot n & ( 18 ) \\ {log}_{2} ( {4}^{L} ) + {log}_{2} ( {4}^{f} ) = {log}_{2} ( n \cdot n ) & ( 19 ) \\ 2 L + 2 f = {log}_{2} ( n \cdot n ) & ( 20 ) \\ L + f = \frac{{log}_{2} ( n \cdot n )}{2} & ( 21 ) \\ L = \frac{{log}_{2} ( n \cdot n )}{2} - f & ( 22 )\end{matrix}$$

This new form of L may be substituted into the value a that is input to the look-up table R for the reciprocal square root as

$$\begin{matrix}a = {2}^{- 2 L} ( n \cdot n ) = {2}^{- 2 ( \frac{{log}_{2} ( n \cdot n )}{2} - f )} ( n \cdot n ) & ( 23 ) \\ = {2}^{( - {log}_{2} ( n \cdot n ) + 2 f )} ( n \cdot n ) = \frac{{2}^{2 f}}{n \cdot n} ( n \cdot n ) = {2}^{2 f} = {4}^{f} & ( 24 )\end{matrix}$$

The fractional value f is a value in the range [0.0, 0.999999 . . . ]. Thus, the range of the input a to the look-up table is [1.0, 3.999999 . . . ] when right-shifting is applied to make a large value of n·n smaller, or conversely, left-shifting is applied to make a small value larger. Recall that the range of L may be [−8, 19], and a right-shift by a negative number is a left-shift by a positive number. The value b returned or output from the look-up table R is in the range (0.5, 1.0].

The half-length normal vector (h\hat{n}) at 306 for the case of h=½ is then

$$\begin{matrix}\frac{\hat{n}}{2} = \frac{S}{2} n = \frac{1}{2} ( R ( n \cdot n \text{>>} 2 L ) \text{>>} L ) [ {n}_{x} {n}_{y} ] & ( 25 ) \\ = ( R ( n \cdot n \text{>>} 2 L ) [ {n}_{x} {n}_{y} ] ) \text{>>} ( L + 1 ) & ( 26 )\end{matrix}$$

The final mathematical solution may be obtained by multiplying the value b returned from the look-up table R by the components of the normal vector, then applying the shift to each component as

$$\begin{matrix}\frac{{\hat{n}}_{x}}{2} = ( R ( n \cdot n \text{>>} 2 L ) {n}_{x} ) \text{>>} ( L + 1 ) \\ and & ( 27 ) \\ \frac{{\hat{n}}_{y}}{2} = ( R ( n \cdot n \text{>>} 2 L ) {n}_{y} ) \text{>>} ( L + 1 ) . & ( 28 )\end{matrix}$$

The implementation solution adjusts for a change in fixed-point format. The value returned by the look-up table R(n·n>>2L) is u1.8 with range (0.5, 1.0], and the normal vector component nₓ or n_{y} is s19.8. Hence, the product of the two is s19.16. To obtain an output format of s1.8, an adjustment of shifting right by an additional 8 bits is needed to convert from s19.16 to s1.8. With this adjustment, the final solution is as follows.

$$\begin{matrix}{\overline{n}}_{x} = \frac{{\hat{n}}_{x}}{2} \text{>>} 8 = ( R ( n \cdot n \text{>>} 2 L ) {n}_{x} ) \text{>>} ( L + 9 ) \\ and & ( 29 ) \\ {\overline{n}}_{y} = \frac{{\hat{n}}_{y}}{2} \text{>>} 8 = ( R ( n \cdot n \text{>>} 2 L ) {n}_{y} ) \text{>>} ( L + 9 ) . & ( 30 )\end{matrix}$$

The vertices for triangle 0 and triangle 1 are then provided at 205 in FIG. 3.

In summary, shifting is performed in two places. First, the input to the look-up table is shifted by 2L. With L in the range [−8, 19], the shift is right for positive values and left by the absolute value for negative values. The input to the look-up table is in the range [1.0, 3.999999 . . . ] or [0x1.0000, 0x3.FFFF] in u2.16 format, and the output is in the range (0.5, 1.0] or [0x0.80, 0x1.00] in u1.8 format. Thus, the subject matter disclosed herein provides 8 bits of accuracy/resolution for normal vector components that are in an s18.8 format. The second shift is of scaled normal vector components to the right by L+9 bits. The range of this shift is [1, 28], which is always positive and the shift is always to the right.

To further illustrate the technique disclosed herein, consider an example line segment in which n·n=48. The integer L would then be └log₄(n·n)┘=2, which is a power of 2 so that multiplication using the scale factor may be performed by shifting binary numbers. S would be

$$S = \frac{1}{\sqrt{48}} = \frac{\frac{1}{{2}^{L}}}{\frac{1}{{2}^{L}} \sqrt{48}} = \frac{\frac{1}{{2}^{L}}}{\sqrt{\frac{48}{{2}^{2 L}}}} = \frac{\frac{1}{4}}{\sqrt{\frac{48}{{2}^{L}}}} = \frac{\frac{1}{4}}{\sqrt{\frac{48}{16}}} = \frac{\frac{1}{4}}{\sqrt{3}} . \qquad ( 31 )$$

A lookup table can approximate reciprocal square root. Applying lookup directly to 48 would require a large table to obtain 1/\sqrt{48}. The subject matter disclosed herein applies the lookup to 3 in a small table to obtain 1/\sqrt{3} followed by shifting that value in binary arithmetic because ¼ is a power of two.

As will be recognized by those skilled in the art, the innovative concepts described herein can be modified and varied over a wide range of applications. Accordingly, the scope of claimed subject matter should not be limited to any of the specific exemplary teachings discussed above, but is instead defined by the following claims.

What is claimed is:

1. A graphics processing system, comprising:
a lookup table containing a plurality of values representing reciprocal square roots for normal vectors to a corresponding plurality of line segments; and
a graphics processor that receives a first vertex and a second vertex of a first line segment that is to be rendered as two triangles, the graphics processor inputting an input value to the lookup table, the input value comprising 2 to a negative power of an integer L times a dot product of a normal vector to the first line segment with itself, the graphics processor receiving an output value from the lookup table that represents a reciprocal square root of the normal vector to the first line segment and determining a unit normal vector to the first line segment by multiplying the normal vector to the first line segment by the output value received from the lookup table, the graphics processor further determining a first half unit normal vector and a second half unit normal vector to the first line segment from the unit normal vector and the first vertex and the second vertex of the first line segment, and determining a first triangle and a second triangle based on the first and second half normal vectors and the first vertex and the second vertex of the first line segment, the first and second triangles each comprising a hypotenuse and being joined together by their hypotenuses.

2. The graphics processing system of claim 1, wherein the graphics processor further renders the first line segment by rendering the first and second triangles.

3. The graphics processing system of claim 2, wherein the graphics processor further scales a length of each of the first and second half normal vectors to be half of a predetermined line width of the rendered line segment.

4. The graphics processing system of claim 1, wherein an input range of the lookup table spans from 1.0 inclusive to 4 non-inclusive, and
wherein an output range of the lookup table spans from 0.5 non-inclusive to 1.0 inclusive.

5. The graphics processing system of claim 1, wherein L ranges from −8 inclusive to 19 inclusive.

6. The graphics processing system of claim 1, wherein the first half unit normal vector and the second half unit normal vector each comprise 8 fractional bits of resolution.

7. The graphics processing system of claim 1, wherein a time from inputting the input value to the lookup table to receiving the output value from the lookup table takes one clock cycle of the graphics processor.

8. A method to graphically represent a line segment by two triangles, the method comprising:
receiving at a graphics processor a first vertex and a second vertex of a line segment;
determining by the graphics processor a scaling factor that is equal to 4 to a power of an integer L;
inputting an input value to a lookup table by the graphics processor, the input value comprising 2 to a negative power of L times a dot product of a normal vector to the line segment with itself;
receiving by the graphics processor from the lookup table an output value that equals a reciprocal square root of the input to the lookup table;
determining by the graphics processor a unit normal vector to the line segment by dividing the normal vector to the line segment by the output value received from the lookup table;
determining by the graphics processor a first half normal vector and a second half normal vectors to the line segment from the unit normal vector and the first vertex and the second vertex of the line segment;
determining by the graphics processor a first triangle and a second triangle based on the first and second half normal vectors and the first vertex and the second vertex of the line segment, the first and second triangles each comprising a hypotenuse and being joined together by their hypotenuses; and
graphically rendering the line segment by the graphics processor by rendering the first and second triangles.

9. The method of claim 8, wherein determining the first and second half normal vectors further comprises scaling a length of each of the first and second half normal vectors to be half of a predetermined line width of the rendered line segment.

10. The method of claim 8, wherein an input range of the lookup table spans from 1.0 inclusive to 4 non-inclusive.

11. The method of claim 10, wherein an output range of the lookup table spans from 0.5 non-inclusive to 1.0 inclusive.

12. The method of claim 8, wherein L ranges from −8 inclusive to 19 inclusive.

13. The method of claim 8, wherein the first half normal vector and the second half normal vector each comprise 8 fractional bits of resolution.

14. The method of claim 8, wherein inputting the input value to the lookup table and receiving the output value from the lookup table takes one clock cycle of the graphics processor.

15. A method to graphically represent a line segment by two triangles, the method comprising:
receiving at a graphics processor a first vertex v₀ and a second vertex v₁ of a line segment;
determining by the graphics processor a scaling factor P=4^{L} in which L is an integer value given by L=└log₄(n·n)┘ in which n is a normal vector to the line segment, and n·n is a dot product of the normal vector n with itself;
inputting an input value a into a lookup table by the graphics processor, the input value comprising a=2^{-2L} (n·n);
receiving by the graphics processor from the lookup table an output value b=S(2⁻²L(n·n));
determining by the graphics processor a unit normal vector \hat{n} to the line segment by multiplying the normal vector n to the line segment by the output value b received from the lookup table;
determining by the graphics processor a first normal half vector h [symbol] and a second half normal vector h [symbol] to the line segment from the unit normal vector \hat{n} and the first vertex v₀ and the second vertex v₁ of the line segment;
determining by the graphics processor a first triangle and a second triangle based on the first half normal vector h [symbol] and the second half normal vector h [symbol] and the first vertex v₀ and the second vertex v₁ of the line segment, the first and second triangles each comprising a hypotenuse and being joined together by their hypotenuses; and
graphically rendering the line segment by the graphics processor by rendering the first and second triangles.

16. The method of claim 15, wherein determining the first half normal vector [symbol] and the second half normal vector h [symbol] further comprises scaling a length of each of the first half normal h [symbol] vector and the second half normal vector h [symbol] to be half of a predetermined line width of the rendered line segment.

17. The method of claim 15, wherein an input range of the lookup table spans from 1.0 inclusive to 4 non-inclusive.

18. The method of claim 15, wherein an output range of the lookup table spans from 0.5 non-inclusive to 1.0 inclusive.

19. The method of claim 15, wherein L ranges from −8 inclusive to 19 inclusive.

20. The method of claim 15, wherein the first half normal vector h [symbol] and the second half normal vectors h [symbol] each comprise 8 fractional bits of resolution.
